(19) United States
(12) Patent Application Publication
(10) Pub. No.: US 2014/0305550 A1
(43) Pub. Date: Oct. 16, 2014

(54) HIGH STRENGTH HOT ROLLED STEEL SHEET AND METHOD FOR PRODUCING THE SAME

(71) Applicant: JFE Steel Corporation, Tokyo (JP)

(72) Inventors: Tamako Ariga, Tokyo (JP); Yoshimasa Funakawa, Tokyo (JP); Yasunobu Uchida, Tokyo (JP)

(21) Appl. No.: 14/355,114

(22) PCT Filed: Nov. 6, 2012
(86) PCT No.: PCT/JP2012/007088

§ 371 Date: Apr. 29, 2014

(30) Foreign Application Priority Data
Nov. 8, 2011 (JP) 2011-244269

(51) Int. Cl. C22C 38/28; C22C 38/26; C22C 38/24; C22C 38/16; C22C 38/14; C22C 38/60; C22C 38/10; C22C 38/08; C22C 38/06; C22C 38/04; C22C 38/02; C22C 38/00; C21D 8/02; C22C 38/12

(52) U.S. Cl. CPC C22C 38/28; C21D 8/0263; C22C 38/26; C22C 38/24; C22C 38/16; C22C 38/14; C22C 38/12; C22C 38/10; C22C 38/08; C22C 38/06; C22C 38/04; C22C 38/02; C22C 38/008; C22C 38/002; C22C 38/60
USPC 148/537; 148/602; 148/337; 148/332; 148/336; 148/330; 148/333

(57) ABSTRACT

A high strength hot rolled steel sheet has a matrix that has a ferrite phase with an area ratio of 95% or more with respect to an overall structure; and a structure where a fine carbide is dispersedly precipitated, the fine carbide containing Ti and V having an average particle size of less than 10 nm in the matrix, the fine carbide has a volume fraction of 0.0050 or more with respect to the overall structure, a proportion of a number of carbides with a particle size of 30 nm or more containing Ti is less than 10% with respect to a total number of carbides, the high strength hot rolled steel sheet has a tensile strength of 980 MPa or more.

### TECHNICAL FIELD

This disclosure relates to a high strength hot rolled steel sheet that is suitable for raw material of transportation equipment such as a component for automobile and a structural material or similar material, features excellent formability, in particular, excellent stretch-flange formability, bending characteristics, and material stability, and has a tensile strength (TS) of 980 MPa or more. The disclosure also relates to a method of producing the high strength hot rolled steel sheet.

### BACKGROUND

From the aspect of global environment conservation, to reduce CO₂ emissions, achieving weight reduction of automobile bodies while maintaining strength to improve fuel consumption of the automobile has been an extremely important problem in the automobile industry. To achieve weight reduction of the automobile bodies while maintaining their strength, it is effective to increase the strength of a steel sheet to be a raw material for automobile components to provide a thinner steel sheet. Therefore, recently, high tensile strength steel sheets have been actively used for automobile components. In the automobile industry, for example, as raw materials for underbody components, application of steel sheets with tensile strength (TS) of 780 MPa level or more and, further, tensile strength (TS) of 980 MPa level or more have been considered.

On the other hand, most of the automobile components using a steel sheet as raw material are shaped by press processing, burring processing, or similar processing. Therefore, it is required to stably achieve the steel sheet for automobile components having excellent formability (stretch-flange formability and bending formability). Press forming a steel sheet of partially different strength changes the amount of springback in proportion to the strength, resulting in kinking of components. Accordingly, to obtain components with desired strength and accuracy of dimensions and form, it is extremely important that strength and formability of a steel sheet employed as a raw material be uniform in the width direction of the steel sheet.

Regarding a technique to achieve high strengthening of steel sheet while ensuring excellent formability, for example, Japanese Unexamined Patent Application Publication No. 2006-161112 proposes a technique providing a high strength hot-rolled steel sheet that contains, by mass %, C: 0.08 to 0.20%, Si: 0.001% or more to less than 0.2%, Mn: more than 1.0% to 3.0% or less, Al: 0.001 to 0.5%, V: more than 0.1% to 0.5% or less, Ti: 0.05% or more to less than 0.2%, and Nb: 0.005 to 0.5%, and satisfies the following three expressions: (Expression 1) (Ti/48+Nb/93)×C/12≦4.5×10⁻⁵, (Expression 2) 0.5≦(V/51+Ti/48+Nb/93)/(C/12)≦1.5, and (Expression 3) V+Ti×2+Nb×1.4+C×2 +Mn×0.1≧0.80. Balance is Fe and inevitable impurities. The high strength hot-rolled steel sheet has a steel sheet structure where ferrite with an average grain size of 5 μm or less and hardness of 250 Hv or more is contained 70 volume % or more. The high strength hot-rolled steel sheet has a strength of 880 MPa or more and a yield ratio of 0.80 or more.

Japanese Unexamined Patent Application Publication No. 2009-052139 proposes a technique providing a high strength steel sheet that has a chemical composition contains, by mass %, C: 0.02% or more to 0.20% or less, Si: 0.3% or less, Mn: 0.5% or more to 2.5% or less, P: 0.06% or less, S: 0.01% or less, Al: 0.1% or less, Ti: 0.05% or more to 0.25% or less, V: 0.05% or more to 0.25% or less. Balance is Fe and inevitable impurities. The high strength steel sheet has a substantial ferrite single-phase structure and contains precipitates having a size of less than 20 nm, The precipitates contains 200 mass ppm or more to 1750 mass ppm or less Ti and 150 mass ppm or more to 1750 mass ppm or less V. Solid solution V is 200 mass ppm or more to less than 1750 mass ppm. That technique provides a high strength steel sheet having excellent stretch-flange characteristics after processing and corrosion resistance after painting.

In the technique described in Japanese Unexamined Patent Application Publication No. 2009-052139, a precipitate in a steel sheet is fine-grained (size of less than 20 nm) to enhance strength of the steel sheet. As a precipitate that allows maintaining the precipitate contained in steel sheet to be fine, the precipitate containing Ti and V is employed. Additionally, by designing an amount of solid solution V contained in the steel sheet to a desired range, stretch-flange characteristics after processing is improved. That approach results in a high strength hot rolled steel sheet that is excellent in stretch-flange formability after processing and corrosion resistance after painting and has a tensile strength of 780 MPa or more.

However, in the technique proposed in Japanese Unexamined Patent Application Publication No. 2006-161112, stretch-flange formability is not considered. Accordingly, to ensure a tensile strength of 780 MPa or more, a steel sheet structure is required to be a complex structure of a ferrite phase and a hard phase. However, performing burring processing on a steel sheet with such complex structure, cracks are initiated at interfaces between the ferrite and hard phases. That is, with the technique proposed in Japanese Unexamined Patent Application Publication No. 2006-161112, to ensure a tensile strength of 780 MPa or more, or further 980 MPa or more, there is a problem that sufficient stretch-flange formability cannot be always obtained. Additionally, controlling the second phase (the hard phase) is difficult. Accordingly, it is extremely difficult to produce a uniform material,

Meanwhile, according to the technique proposed in Japanese Unexamined Patent Application Publication No. 2009-052139, specifying a precipitate of less than 20 nm ensures manufacturing hot-rolled steel sheets featuring excellent formability (elongation and stretch-flange formability) and strength up to about 780 MPa level. However, in strengthening a steel sheet with precipitates, precipitates with finer particle size, which are less than 10 nm, is the main part of the strengthening mechanism. Accordingly, specification of precipitates of less than 20 nm alone cannot obtain sufficient precipitation strengthening. It is difficult to produce a steel sheet with tensile strength of 980 MPa or more. Coexisting precipitates of 20 nm to several nm makes an amount of strengthening with precipitate instable. There is a problem that the strength in a steel sheet width direction does not become uniform.

As described above, conventional techniques, obtaining high tensile strength steel sheets with stable strength and excellent stretch-flange formability is extremely difficult.

It could therefore be helpful to provide a high strength hot rolled steel sheet and a method of manufacturing the high strength hot rolled steel sheet suitable for transportation equipment and structural materials, in particular, automobile components, and has a tensile strength of 980 MPa or more, excellent formability (in particular, stretch-flange formability and bending formability), and excellent uniformity in strength and formability.

### SUMMARY

We provide:

[1] A high strength hot rolled steel sheet includes a chemical composition and a structure (microstructure). The composition consists essentially of: C: more than 0.05% to 0.13% or less; Si: 0.3% or less; Mn: 0.5% or more to 2.0% or less; P: 0.025% or less; S: 0.005% or less; N: 0.0060% or less; Al: 0.1% or less; and Ti: 0.07% or more to 0.18% or less, V: more than 0.13% to 0.30% or less on a mass percent basis, such that Ti and V contents satisfy the following Formula (1). Solid solution V is 0.05% or more to less than 0.15%. Balance comprises Fe and inevitable impurities. A matrix has a ferrite phase with an area ratio of 95% or more with respect to an overall structure. In the structure, fine carbide is dispersedly precipitated. The fine carbide contains Ti and V has an average particle size of less than 10 nm in the matrix. The fine carbide has a volume fraction of 0.0050 or more with respect to the overall structure. A proportion of a number of carbides with particle size of 30 nm or more containing Ti is less than 10% with respect to a total number of carbides. The high strength hot rolled steel sheet has a tensile strength of 980 MPa or more.

0.25<Ti+V≦0.45 (1)

(where Ti and V are respective contents of the elements (by mass %))

In the high strength hot rolled steel sheet according to [1], the chemical composition further contains at least one selected from a group consisting of Nb and Mo by 1% or less in total on a mass percent basis.

[3] In the high strength hot rolled steel sheet according to [1], the chemical composition further contains at least one selected from a group consisting of Cu, Sn, Ni, Ca, Mg, Co, As, Cr, W, B, Pb, Ta, and Sb by 1% or less in total on a mass percent basis.

[4] In the high strength hot rolled steel sheet according to [2], the chemical composition further contains at least one selected from a group consisting of Cu, Sn, Ni, Ca, Mg, Co, As, Cr, W, B, Pb, Ta, and Sb by 1% or less in total on a mass percent basis.

[5] The high strength hot rolled steel sheet according to any one of [1] to [4] further include a plating layer formed at a surface of the high strength hot rolled steel sheet.

[6] In the high strength hot rolled steel sheet according to any one of [1] to [4], the high strength hot rolled steel sheet has a hole expansion ratio of 40% or more.

[7] In the high strength hot rolled steel sheet according to [6], the high strength hot rolled steel sheet has a ratio of limit bending radius of 0.9 or less.

[8] In the high strength hot rolled steel sheet according to [7], a difference in a tensile strength between a center position of a sheet width and a position at one-quarter width of the steel sheet is 15 MPa or less, a difference in a hole expansion ratio among the positions is 10% or less, and a difference in a ratio of limit bending radius among the positions is 0.15 or less.

[9] A method of producing a high strength hot rolled steel sheet with a tensile strength of 980 MPa or more includes: preparing, hot-rolling, cooling, and coiling. The preparing prepares a steel material with a component chemical according to any one of [1] to [4]. The hot-rolling hot-rolls the steel material including rough rolling and finish rolling at a rolling temperature of 880° C. or more to form a hot-rolled steel sheet. The cooling cools the hot-rolled steel sheet at an average cooling rate of 10° C./sec. or more subsequent to completion of the finish rolling. The coiling coils the hot-rolled steel sheet at 550° C. or more to less than 700° C.

[10] The method according to [9] further includes plating a surface of the hot-rolled steel sheet subsequent to the coiling.

Our methods ensure industrially stable production of a high strength hot rolled steel sheet with excellent formability, a strength of tensile strength of 980 MPa or more, and excellent material stability. The high strength hot rolled steel sheet is suitable for a raw material for automobile components with a complicated cross-sectional shape when pressing, thus providing an industrially useful effect.

### DETAILED DESCRIPTION

Hereinafter, our steel sheets and methods will be described in detail.

We investigated various factors affecting high strengthening and formability such as stretch-flange formability of a hot-rolled steel sheet and material stability in a width direction of the hot-rolled steel sheet in order to solve the above problems. As a result, we discovered the following:

1) Designing the steel sheet structure to have a ferrite single-phase structure with low dislocation density and excellent formability and further precipitation strengthening by dispersed precipitation of the fine carbide improve the strength of the hot-rolled steel sheet and obtain excellent stretch-flange formability.

2) To obtain a hot-rolled steel sheet with excellent formability and a high strength of a tensile strength of 980 MPa or more, it is necessary to dispersedly precipitate fine carbide where the average particle size effective for precipitation strengthening is less than 10 nm at a desired volume fraction.

3) As the fine carbide that contributes to precipitation strengthening, carbide containing Ti and V is effective from the aspect of achieving strength or similar purpose.

4) To provide stable strength to the hot-rolled steel sheet, reduction of carbide with particle size of 30 nm or more, which does not contribute to precipitation strengthening, is effective.

5) To make uniform the strength of hot-rolled steel sheet in a width direction, contents of Ti and V, which are precipitation strengthening elements, are specified. This is effective in reducing a structural change at an end of the steel sheet in the width direction and reducing deterioration of strength.

6) The presence of a predetermined amount of solid solution V in the hot-rolled steel sheet stably improves bending formability of the steel sheet.

7) To substantially design a matrix in a steel sheet structure as a ferrite single-phase and to dispersedly precipitate fine carbide containing Ti and V of less than 10 nm as described above at a desired volume fraction, controlling a coiling temperature during manufacturing the hot-rolled steel sheet to be a predetermined temperature is important.

Reasons for limiting the structure of the steel sheet will be described. We provide a hot-rolled steel sheet that has a matrix with an area ratio of a ferrite phase of 95% or more with respect to an overall structure. Fine carbide with average particle size of less than 10 nm containing Ti and V is dispersedly precipitated in the matrix. The fine carbide has a volume fraction of 0.0050 or more with respect to the overall structure. A proportion of the number of carbides with particle size of 30 nm or more containing Ti is less than 10% with respect to the total number of carbides. The hot-rolled steel sheet may have a plating layer on the surface of the hot-rolled steel sheet.

Ferrite Phase: the Area Ratio of 95% or More with Respect to the Overall Structure

A ferrite phase is necessary to be formed to maintain formability (stretch-flange formability) of the hot-rolled steel sheet. It is effective to achieve a ferrite phase with a low dislocation density and excellent ductility as the structure of the hot-rolled steel sheet to improve the formability of the hot-rolled steel sheet. In particular, it is preferred to have a ferrite single-phase as the structure of the hot-rolled steel sheet to improve the stretch-flange formability. However, even when the structure of the hot-rolled steel sheet is not a complete ferrite single-phase, it is only necessary to have a substantially ferrite single-phase structure, that is, to have a ferrite phase with an area ratio of 95% or more with respect to the overall structure to sufficiently provide the above-described effects. Accordingly, the area ratio of the ferrite phase with respect to the overall structure is preferably to be 95% or more, more preferably, 97% or more.

The structure other than the ferrite phase employs cementite, pearlite, a bainite phase, a martensite phase, a retained austenite phase, and a similar phase. The acceptable sum of these phases is area ratio of 5% or less with respect to the overall structure.

Fine Carbide Containing Ti and V

The carbide containing Ti and V is more likely to be fine carbide with an extremely small average particle size. That increases the strength of the hot-rolled steel sheet by precipitating dispersed fine carbide in the hot-rolled steel sheet, the dispersed fine carbide to be precipitated is preferred to be fine carbide containing Ti and V.

Conventionally, for high strengthening of the steel sheet, use of Ti carbide not containing V was the mainstream. In contrast, our steel sheets feature use of carbide containing V in addition to Ti.

Ti easily forms carbide. Therefore, Ti carbide without V is likely to be coarse and contributes less to high strengthening of the steel sheet. Accordingly, to provide a desired strength (tensile strength: 980 MPa or more) to the steel sheet, adding more Ti and forming Ti carbide are necessary. On the other hand, excessive addition of Ti may cause reduction of formability (stretch-flange formability). This fails to obtain excellent formability applicable to a raw material for underbody components with a complicated cross-sectional shape or similar component.

On the other hand, that tendency that V forms carbide is lower than that of Ti. Accordingly, the use of V is effective to reduce coarsening of carbide. Therefore, we employ a compound carbide that contains both Ti and V as carbide to be dispersedly precipitated. The fine carbide containing Ti and V does not mean carbide where each individual carbide (i.e., Ti carbide or V carbide) is separately contained in a structure, but a compound carbide containing both Ti and V in one fine carbide.

Average Particle Size of Fine Carbide Containing Ti and V: Less than 10 nm

The average particle size of the fine carbide is extremely important to result in a desired strength to a hot-rolled steel sheet. One feature is that the average particle size of the fine carbide containing Ti and V is designed to be less than 10 nm. When the fine carbide is precipitated in the matrix, this fine carbide acts to resist movement of dislocations occurring when the steel sheet is deformed. This action strengthens the hot-rolled steel sheet. The effect becomes remarkable with smaller fine carbide. Designing the average particle size of the fine carbide to less than 10 nm makes the above-described action to be further remarkable. Accordingly, the average particle size of the fine carbide containing Ti and V is preferably to be less than 10 nm, more preferably, 5 nm or less.

Volume Fraction of Fine Carbide Containing Ti and V with Respect to the Overall Structure: 0.0050 or More

To produce a desired strength to the hot-rolled steel sheet (a tensile strength: 980 MPa or more), a dispersed precipitation state of the fine carbide containing Ti and V is extremely important. The fine carbide that contains Ti and V with average particle size of less than 10 nm is dispersedly precipitated such that the structural fraction of fine carbide with respect to the overall structure becomes 0.0050 or more in volume fraction. If the volume fraction is less than 0.0050, even if the average particle size of the fine carbide containing Ti and V is less than 10 nm, the amount of the fine carbide is little. Accordingly, it is difficult to reliably ensure the desired hot-rolled steel sheet strength (tensile strength: 980 MPa or more). Accordingly, it is preferred that the volume fraction be 0.0050 or more, more preferably, 0.0070 or more.

Although precipitation in rows, which is a main precipitation state, is mixed with random precipitation of the fine carbide as a precipitation state of the fine carbide containing Ti and V, this does not have any influence on the characteristics. Various precipitation states are collectively referred to as “dispersed” precipitation regardless of the state of precipitation.

Proportion of the Number of Carbides with Particle Size of 30 nm or More Containing Ti with Respect to the Total Number of Carbides: Less than 10%

If a steel sheet contains carbide with particle size of 30 nm or more containing Ti, the steel sheet strength becomes unstable and formability (stretch-flange formability) also becomes unstable. Therefore, if such coarse carbide is significantly present, the above-described desired effects are not achieved. Accordingly, it is preferred that a proportion of the number of carbides with a particle size of 30 nm or more containing Ti with respect to the total number of carbides be less than 10%, more preferably, 5% or less.

Next, reasons for limiting the chemical composition of the hot-rolled steel sheets will be described. Hereinafter, “%” used for the chemical composition means “mass %”, unless otherwise stated.

C: More than 0.05% and 0.13% or Less

C is a necessary element to form the fine carbide and strengthen the steel. If the C content is 0.05% or less, the fine carbide with desired structure fraction cannot be obtained, and a tensile strength of 980 MPa or more cannot be obtained. On the other hand, if the C content exceeds 0.13%, strength excessively increases, and formability (stretch-flange formability and bending formability) deteriorates. Accordingly, the C content is preferably more than 0.05% to 0.13 or less, more preferably, 0.07% or more to 0.11% or less.

Si: 0.3% or Less

Si is a solid-solution strengthening element and an element effective to strengthen the steel. However, if the Si content exceeds 0.3%, the C precipitation from the ferrite phase is promoted and coarse Fe carbide is likely to precipitate at the grain boundaries. This reduces stretch-flange formability. Additionally, excessive Si content adversely affects plating performance of the steel sheet. Accordingly, the Si content is preferably 0.3% or less, more preferably, 0.05% or less.

Mn: 0.5% or More to 2.0% or Less

Mn is a solid-solution strengthening element and an element effective to strengthen the steel. Mn is also an element that lowers the Ar3 transformation temperature of a steel. The Ar₃ transformation temperature becomes high if the Mn content is less than 0.5%. Accordingly, the carbide containing Ti is not sufficiently fine-grained and, also, an amount of solid solution strengthening is not enough, thus failing to obtain a tensile strength of 980 MPa or more. On the other hand, if the Mn content exceeds 2.0%, segregation becomes remarkable and a phase other than the ferrite phase, that is, a hard phase is formed. This reduces stretch-flange formability. Accordingly, the Mn content is preferably 0.5% or more to 2.0% or less, more preferably, 1.0% or more to 1.8% or less.

P: 0.025% or Less

P is a solid-solution strengthening element, and an element effective to strengthen the steel. However, if the P content exceeds 0.025%, segregation becomes remarkable. This reduces stretch-flange formability. Accordingly, the P content is preferably 0.025% or less, more preferably, 0.02% or less.

S: 0.005% or Less

S is an element that reduces hot workability (hot rolling property) and increases hot crack sensitivity of the slab. Additionally, S is present as MnS in the steel, thus deteriorating formability (the stretch-flange formability) of the hot-rolled steel sheet. S forms TiS in the steel and reduces Ti precipitated as fine carbide. Accordingly, S is reduced as much as possible. The S content is preferably to be 0.005% or less.

N: 0.0060% or Less

N is a harmful element and is preferred to be reduced as much as possible. In particular, if the N content exceeds 0.0060%, coarse nitride is generated in the steel. This reduces stretch-flange formability. Accordingly, the N content is preferably 0.0060% or less.

Al: 0.1% or Less

Al is an element acting as a deoxidizer. To obtain this effect, the Al content is preferably 0.001% or more. However, if the Al content exceeds 0.1%, stretch-flange formability is reduced. Therefore, the Al content is preferably Al: 0.1% or less.

Ti: 0.07% or More to 0.18% or Less

Ti is one of the important elements. Ti is an element that contributes to high strengthening of the steel sheet while obtaining excellent formability (stretch-flange formability) by forming compound carbide with V. A desired strength of the hot-rolled steel sheet cannot be obtained if the Ti content is less than 0.07%. On the other hand, if the Ti content exceeds 0.18%, coarse TiC (carbide containing Ti) is likely to be precipitated, thus making the strength of steel sheet unstable. Accordingly, the Ti content is preferably 0.07% or more to 0.18% or less, more preferably, 0.10% or more to 0.16% or less.

V: More than 0.13% to 0.30% or Less

V is one of the important elements. As described above, V is an element that contributes to high strengthening of the steel sheet while obtaining excellent elongation and stretch-flange formability by forming compound carbide with Ti. V is an extremely important element that stably achieves excellent mechanical characteristics (strength) of the steel sheet by forming compound carbide with Ti and contributes to material uniformity of the steel sheet. If the V content is 0.13% or less, a coarse TiC, which adversely affects strength of steel sheet, stretch-flange formability, and material uniformity, is likely to be generated. On the other hand, if the V content exceeds 0.30%, the strength becomes excessively high, thus resulting in deterioration of formability (stretch-flange formability). Accordingly, the V content is preferably more than 0.13% to 0.30% or less.

The hot-rolled steel sheet contains Ti and V such that Formula (1) is satisfied within the above-described range.

0.25<Ti+V≦0.45 (1)

(where Ti and V are respective contents of the elements (by mass %)).

The above-described Formula (1) is a condition to be satisfied in providing the steel sheet with stable strength and formability (stretch-flange formability and bending formability). If the total content of Ti and V becomes 0.25% or less, designing a volume fraction of the fine carbide containing Ti and V with respect to the overall structure to 0.0050 or more is difficult. On the other hand, if the total content of Ti and V exceeds 0.45%, steel sheet strength becomes excessively high, resulting in deterioration of formability (stretch-flange formability). Accordingly, it is preferred that the total content (%) of Ti and V be more than 0.25% to 0.45% or less. This makes generation of coarse TiC in the steel sheet difficult. Thus, the fine carbide containing Ti and V is generated at a desired volume fraction, stabilizing steel sheet strength and also stabilizing formability (stretch-flange formability and bending formability).

Solid Solution V: 0.05% or More to Less than 0.15%

Solid solution V mainly dissolves into ferrite grain boundaries and strengthens those grain boundaries. This extremely and effectively acts on formability of the steel sheet, in particular, improvement of bending formability. In V contained in the hot-rolled steel sheet, if the content of the solid solution V is less than 0.05%, the above-described effect is not sufficiently expressed. On the other hand, if the content of the solid solution V is 0.15% or more, fine carbide containing Ti and V, required to obtain the desired steel sheet strength (tensile strength: 980 MPa or more), cannot be sufficiently obtained. Accordingly, in V contained in the hot-rolled steel sheet, the amount of solid solution V is preferably 0.05% or more to less than 0.15%.

The compositions described above are basic compositions. In addition to the above-described basic compositions, at least one selected from the group consisting of Nb and Mo can be contained by 1% or less in total. Nb and Mo form a compound carbide by composite precipitation together with Ti and V and contribute to obtaining a desired strength. Therefore, Nb and Mo can be contained as necessary. To obtain such an effect, it is preferred that Nb and Mo be contained at 0.005% or more in total. However, since excessively Nb and Mo tends to deteriorate elongation, it is preferred that the total amount of any one or two of Nb and Mo be 1% or less, more preferably, 0.5% or less.

In addition to the above-described basic compositions, at least one selected from the group consisting of Cu, Sn, Ni, Ca, Mg, Co, As, Cr, W, B, Pb, Ta, and Sb may be contained by 1% or less in total, preferably, 0.5% or less. As constituents other than ones described above, Fe and the unavoidable impurities are contained.

A plating layer may be formed at a surface of a hot-rolled steel sheet with the above-described structure and composition. The type of plating layer is not specifically limited. Any conventionally known layer such as an electroplated layer, a hot-dip galvanized layer, and a hot-dip galvannealed layer is applicable.

Next, a description will be given of a method of producing the hot-rolled steel sheets. Hot rolling that includes rough rolling and finish rolling is performed on the steel material (semi-manufactured steel material). After the finish rolling is terminated, cooling and coiling are performed to obtain a hot-rolled steel sheet. At this time, the finish rolling temperature of the finish rolling is 880° C. or more, the average cooling rate of the cooling is 10° C./sec. or more, and the coiling temperature of the coiling is 550° C. or more to less than 700° C. A plating process may be performed on the hot-rolled steel sheet thus obtained.

The method of smelting the semi-manufactured steel material is not specifically limited and can employ a known smelting method using a converter, an electric furnace, or similar furnace. After smelting, in consideration of segregation and similar problem, a slab (semi-manufactured steel material) is preferred to be obtained by a continuous casting method. The slab may be obtained by a known casting method such as an ingot-slab making method and a thin slab continuous casting method. To hot-roll the slab after the casting, the slab may be rolled after being reheated in a heating furnace. The slab may be directly rolled without heating the slab when the temperature is held at a predetermined temperature or more.

Rough rolling and finish rolling are performed on the semi-manufactured steel material obtained as described above. However, it is preferred that carbide be dissolved in the semi-manufactured steel material before rough rolling. When Ti and V, which are carbide-forming elements, are contained, the heating temperature of the steel semi-manufactured material is preferably 1150° C. or more to 1300° C. or less. As described above, when the semi-manufactured steel material before rough rolling is held at a temperature of a predetermined temperature or more and the carbide in the semi-manufactured steel material is dissolved, the process of heating the semi-manufactured steel material before rough rolling can be omitted. It is not necessary to specifically limit the rough rolling conditions.

Finish Rolling Temperature: 880° C. or More

Controlling the finish rolling temperature is important to maintain stretch-flange formability and bending formability of the hot-rolled steel sheet and to reduce the rolling load of finish rolling. A finish rolling temperature of less than 880° C. results in large grains of crystal grains in the surface layer of the hot-rolled steel sheet and deterioration in formability (stretch-flange formability and bending formability) of the steel sheet. Accordingly, the finish rolling temperature is preferably 880° C. or more, more preferably, 900° C. or more. An excessively high finish rolling temperature tends to generate flaws due to secondary scale at the surface of the steel sheet. Thus, the finish rolling temperature is preferably 1000° C. or less.

Average Cooling Rate: 10° C./sec. or More

After finish rolling is terminated, an average cooling rate from a finish rolling temperature to the coiling temperature of less than 10° C./sec. results in a high Ar₃ transformation temperature. Thus, the carbide containing Ti and V cannot be sufficiently fine-grained. Accordingly, the above-described average cooling rate is preferably to be 10° C./sec. or more, more preferably, 30° C./sec. or more.

Coiling Temperature: 550° C. or More to Less than 700° C.

Controlling the coiling temperature is extremely important to achieve, as a structure of the hot-rolled steel sheet, a desired structure over the entire region in the width direction of the steel sheet, that is, a matrix in which the area ratio of a ferrite phase is 95% or more with respect to the overall structure and a structure in which fine carbide, which contains Ti and V and has an average particle size of less than 10 nm, is dispersedly precipitated, and carbide with particle size of 30 nm or more containing Ti is reduced.

If the coiling temperature is less than 550° C., precipitation of the fine carbide containing Ti and V becomes insufficient, thereby failing to obtain the desired steel sheet strength. On the other hand, if the coiling temperature becomes 700° C. or more, the average particle size of the fine carbide containing Ti and V is increased. In this case as well, the desired steel sheet strength cannot be obtained. Accordingly, the coiling temperature is preferably 550° C. or more to less than 700° C., more preferably, 600° C. or more to 650° C. or less.

A plating process may be performed on the hot-rolled steel sheet obtained as described above, and a plating layer may be formed on a surface of the hot-rolled steel sheet. The type of plating process is not specifically limited. A plating process such as a hot-dip galvanizing process and hot-dip galvannealing process can be performed in accordance with conventionally known methods.

As described above, to produce a high strength hot rolled steel sheet having a tensile strength of 980 MPa or more, excellent formability (stretch-flange formability and bending formability) suitable for raw material for automobile components or a similar component with a complicated cross-sectional shape, and uniform and stable material, it is important to dispersedly precipitate the fine carbide containing Ti and V with the average particle size of less than 10 nm over the entire region in the width direction of the steel sheet. It is also important to reduce precipitation of carbide with particle size of 30 nm or more containing Ti over the entire region in the width direction of the steel sheet.

The content of respective Ti and V in the steel, which becomes a semi-manufactured steel material for the hot-rolled steel sheet, is specified, and the total content of these elements (Ti+V) is more than 0.25% to 0.45% or less. This reduces precipitation of carbide with particle size of 30 nm or more containing Ti and controls the composition of the fine carbide such that the fine carbide with average particle size of less than 10 nm is sufficiently dispersedly precipitated. Accordingly, in producing a hot-rolled steel sheet, even at an end of the steel sheet in the width direction, where the material is likely to be unstable in a cooling process after completion of finish rolling, the fine carbide with average particle size of less than 10 nm can be sufficiently dispersedly precipitated. That is, we allow dispersed precipitation of the fine carbide with the average particle size of less than 10 nm over the entire region in the width direction of the hot-rolled steel sheet. This provides uniform and excellent characteristics (tensile strength, stretch-flange formability, and bending formability) over the entire region in the width direction of the hot-rolled steel sheet.

### EXAMPLES

Molten steels with compositions shown in Table 1 were smelted and subjected to continuous casting to have slabs (semi-manufactured steel materials) with a thickness of 250 mm by a known method. These slabs were heated to 1250° C. and then subjected to rough rolling and finish rolling. After finish rolling was terminated, cooling and coiling were performed to obtain hot-rolled steel sheets with a sheet thickness of 2.3 mm and a sheet width of 1400 mm (hot-rolling Nos. in Table 2: 1to 24). The finish rolling temperature at the finish rolling, the average cooling rate at the cooling (the average cooling rate from the finish rolling temperature to the coiling temperature), and the coiling temperature are as shown in Table 2.

Subsequently, some of the hot-rolled sheets obtained as described above (hot-rolling Nos. in Table 2: 3, 5, and 15) were pickled to remove surface scale. Then, an annealing process was performed (annealing temperature: 680° C., holding time at the annealing temperature: 120 sec.). Next, the annealed hot-rolled sheet was dipped in a hot-dip galvanizing bath (plating composition: 0.1% Al—Zn, plating bath temperature: 480° C.). Hot-dip galvanized films with an adhesion amount of 45 g/m² (an adhesion amount of one surface) were formed on both surfaces of the hot-rolled steel sheet. Thus, the hot-dip galvanized steel sheet was formed. Regarding one of the obtained hot-dip galvanized steel sheets (hot-rolling No. in Table 2: 5), an alloying process was performed (an alloying temperature: 520° C.). Thus, a hot-dip galvannealed steel sheet was formed.

TABLE 1

| | Chemical component (mass %) | | | | | | | | | | | | |
|---|---|---|---|---|---|---|---|---|---|---|---|---|---|
| Steel | C | Si | Mn | P | S | N | Al | Ti | V | Nb, Mo | Others | Ti + V | Remarks |
| a | 0.081 | 0.02 | 1.45 | 0.010 | 0.0016 | 0.0034 | 0.045 | 0.162 | 0.223 | — | Cu: 0.01 | 0.385 | Example |
| b | 0.092 | 0.02 | 1.29 | 0.011 | 0.0013 | 0.0041 | 0.042 | 0.146 | 0.251 | — | B: 0.0005 | 0.397 | Example |
| c | 0.091 | 0.02 | 1.49 | 0.010 | 0.0019 | 0.0045 | 0.038 | 0.107 | 0.278 | Nb: 0.007 | Cr: 0.01 | 0.385 | Example |
| d | 0.076 | 0.01 | 1.37 | 0.011 | 0.0027 | 0.0038 | 0.051 | 0.156 | 0.238 | — | Ca: 0.02 | 0.394 | Example |
| e | 0.087 | 0.01 | 1.39 | 0.010 | 0.0017 | 0.0038 | 0.043 | 0.141 | 0.229 | — | — | 0.370 | Example |
| f | 0.106 | 0.03 | 1.19 | 0.013 | 0.0009 | 0.0034 | 0.043 | 0.154 | 0.248 | — | Sn: 0.01, As: 0.01 | 0.402 | Example |
| g | 0.115 | 0.01 | 1.37 | 0.011 | 0.0021 | 0.0036 | 0.042 | 0.125 | 0.283 | — | — | 0.408 | Example |
| h | 0.099 | 0.02 | 1.41 | 0.012 | 0.0008 | 0.0042 | 0.038 | 0.157 | 0.224 | — | W: 0.02 | 0.381 | Example |
| I | 0.093 | 0.01 | 1.49 | 0.010 | 0.0016 | 0.0033 | 0.042 | 0.143 | 0.250 | — | Co: 0.02, Ta: 0.01 | 0.393 | Example |
| j | 0.123 | 0.02 | 1.47 | 0.011 | 0.0021 | 0.0039 | 0.045 | 0.111 | 0.256 | — | — | 0.367 | Example |
| k | 0.095 | 0.01 | 1.52 | 0.010 | 0.0014 | 0.0036 | 0.043 | 0.134 | 0.249 | — | Sb: 0.01 | 0.383 | Example |
| l | 0.098 | 0.02 | 1.45 | 0.011 | 0.0011 | 0.0034 | 0.042 | 0.141 | 0.221 | — | Pb: 0.01 | 0.362 | Example |
| m | 0.096 | 0.02 | 1.39 | 0.011 | 0.0013 | 0.0041 | 0.042 | 0.139 | 0.232 | Mo: 0.005 | — | 0.371 | Example |
| n | 0.086 | 0.02 | 1.43 | 0.010 | 0.0021 | 0.0039 | 0.045 | 0.138 | 0.221 | — | Ni: 0.01 | 0.359 | Example |
| o | 0.091 | 0.01 | 1.52 | 0.012 | 0.0034 | 0.0045 | 0.048 | 0.148 | 0.237 | — | Mg: 0.01 | 0.385 | Example |
| p | 0.021 | 0.02 | 1.47 | 0.012 | 0.0025 | 0.0042 | 0.046 | 0.154 | 0.197 | — | — | 0.351 | Comparative |
| | | | | | | | | | | | | | Example |
| q | 0.087 | 0.02 | 0.44 | 0.011 | 0.0011 | 0.0042 | 0.051 | 0.134 | 0.234 | — | — | 0.368 | Comparative |
| | | | | | | | | | | | | | Example |
| r | 0.089 | 0.02 | 1.46 | 0.010 | 0.0023 | 0.0036 | 0.047 | 0.056 | 0.245 | — | — | 0.301 | Comparative |
| | | | | | | | | | | | | | Example |
| s | 0.097 | 0.01 | 1.43 | 0.011 | 0.0009 | 0.0027 | 0.038 | 0.157 | 0.043 | — | — | 0.200 | Comparative |
| | | | | | | | | | | | | | Example |
| t | 0.218 | 0.01 | 2.05 | 0.012 | 0.0009 | 0.0035 | 0.030 | 0.191 | 0.370 | — | — | 0.561 | Comparative |
| | | | | | | | | | | | | | Example |

TABLE 2

| | | Producing conditions of hot-rolled | | | |
|---|---|---|---|---|---|
| | | steel sheet | | | |
| | | Finish | | | |
| | Hot- | rolling | Average | Coiling | |
| | rolling | temperature | cooling rate | temperature | |
| Steel | No. | (° C.) | (° C./sec.) | (° C.) | Remarks |
| a | 1 | 921 | 30 | 625 | Example |
| | 2 | 923 | 35 | 755 | Comparative |
| | | | | | Example |
| b | 3 | 922 | 35 | 630 | Example |
| | | | | | (plated |
| | | | | | sheet*2) |
| | 4 | 920 | 5 | 630 | Comparative |
| | | | | | Example |
| c | 5 | 918 | 25 | 628 | Example |
| | | | | | (plated |
| | | | | | sheet*3) |
| | 6 | 878 | 30 | 619 | Comparative |
| | | | | | Example |
| d | 7 | 907 | 35 | 645 | Example |
| | 8 | 908 | 35 | 510 | Comparative |
| | | | | | Example |
| e | 9 | 913 | 35 | 640 | Example |
| f | 10 | 914 | 40 | 615 | Example |
| g | 11 | 918 | 40 | 623 | Example |
| h | 12 | 920 | 35 | 614 | Example |
| I | 13 | 920 | 35 | 623 | Example |
| j | 14 | 917 | 40 | 612 | Example |
| k | 15 | 917 | 40 | 612 | Example |
| | | | | | (plated |
| | | | | | sheet*4) |
| l | 16 | 905 | 40 | 628 | Example |
| m | 17 | 908 | 30 | 608 | Example |
| n | 18 | 912 | 35 | 611 | Example |
| o | 19 | 916 | 35 | 632 | Example |
| p | 20 | 918 | 40 | 609 | Comparative |
| | | | | | Example |
| q | 21 | 921 | 40 | 605 | Comparative |
| | | | | | Example |
| r | 22 | 918 | 35 | 612 | Comparative |
| | | | | | Example |
| s | 23 | 906 | 35 | 622 | Comparative |
| | | | | | Example |
| t | 24 | 905 | 35 | 620 | Comparative |
| | | | | | Example |

*1: Average cooling rate from finish rolling temperature to coiling temperature (° C./sec.)
*2Hot-dip galvanized steel sheet
*3Hot-dip galvannealed steel sheet
*4Hot-dip galvanized steel sheet

Specimens were extracted from the hot-rolled steel sheets (the hot-rolled steel sheets, hot-dip galvanized steel sheets, or the hot-dip galvannealed steel sheets) obtained as described above. Subsequently, a structure observation, a precipitation observation, chemical analysis, a tensile test, a hole expanding test, and a bending test were carried out to obtain an area ratio of ferrite phase, an average particle size and a volume fraction of the fine carbide containing Ti and V, a proportion of the number of carbides with particle size of 30 nm or more containing Ti with respect to the total number of carbides, a solid solution V content, a tensile strength, a hole expansion ratio (stretch-flange formability), and a limit ratio of bend radius (bending formability). The testing methods were as follows.

(i) Structure Observation

A specimen was extracted from the obtained hot-rolled steel sheets. The cross section of the specimen in the rolling direction was mechanically polished and etched with nital. Subsequently, a structure photograph (a SEM photograph) taken with a scanning electron microscope (SEM) at a magnification of 3000 times was used to determine the ferrite phase, the type of structure other than the ferrite phase, and the area ratios of these structures by an image analysis device.

(ii) Precipitation Observation

The thin film produced from the obtained hot-rolled steel sheet was observed through a transmission type electron microscope (TEM) at a magnification of 260000 times, to obtain an average particle size and a volume fraction of the fine carbide containing Ti and V.

Regarding the particle size of the fine carbide containing Ti and V, individual particle areas were obtained by image processing based on the observation result of 30 visual fields at a magnification of 260000 times, and the particle sizes were obtained using circular approximation. Subsequently, the arithmetic mean of the particle sizes of respective obtained particles was obtained as the average particle size.

Regarding the volume fraction of the fine carbide containing Ti and V, 10% acetylacetone-1% tetramethylammonium chloride-methanol solution (AA solution) was used to electrolyze a base iron. Subsequently, an extracted residue analysis was performed on filtrated residue to obtain the weight of the carbide containing Ti and V. The obtained weight was divided by a density of the carbide containing Ti and V to obtain the volume. This volume was divided by the volume of the dissolved base iron to obtain the volume fraction.

Regarding the density of the carbide containing Ti and V, density of TiC (4.25 g/cm³) was corrected assuming that a part of Ti atom in TiC crystal was replaced by V atom. The density was thus obtained. That is, Ti and V in the carbide containing Ti and V were measured by extracted residue analysis, and a proportion of V replacing Ti was obtained. Thus, a correction was performed considering atomic weights of Ti and V.

A proportion of the number of carbides with particle size of 30 nm or more containing Ti (%) with respect to the total number of carbides was calculated as follows. The total number of carbides N (total) was obtained based on the TEM observation result of 30 visual fields at a magnification of 260000 times. Subsequently, the areas of the individual carbide particles were measured by image processing, and the particle sizes were calculated by circular approximation. Further, the number of carbides N (30) with particle size of 30 nm or more was obtained. Then, the proportion was calculated by N (30)/N (total)×100 (%).

(iii) Chemical Analysis

A specimen was extracted from the obtained hot-rolled steel sheets. The specimen was dissolved in electrolyte, and the electrolyte was employed as analysis solution. An amount of solid solution V was analyzed by inductively coupled plasma (ICP) atomic emission spectroscopy, ICP mass spectrometry, or atomic absorption analysis method.

(iv) Tensile Test

From the center position and the one-quarter width position in the sheet width of the obtained hot-rolled steel sheets, JIS No. 5 tensile test specimens (JIS Z 2201) were extracted such that the tensile direction was perpendicular to the rolling direction. Subsequently, a tensile test was performed in compliance with the specification of JIS Z 2241 to measure a tensile strength (TS).

(v) Hole Expanding Test

From the center position and the one-quarter width position in the sheet width of the obtained hot-rolled steel sheets, a specimen (in the size of 130 mm×130 mm) was extracted. In the specimen, a hole with an initial diameter d₀ of 10 mm φ was formed by punching processing with a punch. The hole expanding test was carried out using these specimens. A conical punch at a vertex angle of 60° was inserted into the hole to expand the hole. When a crack passed through the steel sheet (the specimen), a diameter “d” of the hole was measured to calculate a hole expansion ratio λ (%) with the following formula.

Hole expansion ratio λ(%)={(d−d₀)/d₀}×100

(vi) Bending Test

From the center portion and the one-quarter width position in the sheet width of the obtained hot-rolled steel sheets, a bending test specimen of width 50 mm and length 100 mm was extracted such that the longitudinal direction of the specimen was perpendicular to the rolling direction. Subsequently, a bending test was performed by a V-bending test in compliance with the specification of JIS Z 2248 (bend angle: 90°). Limit ratio of bend radius of the steel sheet, R/t, was calculated by dividing minimum bend radius R (mm) at which a crack is not initiated by a sheet thickness “t” (mm).

The obtained result was shown in Table 3.

TABLE 3

| | | Structure of hot-rolled steel sheet | | | | | |
|---|---|---|---|---|---|---|---|
| | | | | | | Proportion of the number of | |
| | Hot- | | Area ratio of | Fine carbide containing Ti and V | | carbide with particle size of | Solid |
| | rolling | | ferrite phase | Average particle | | 30 nm or more containing Ti | solution V |
| Steel | No. | Type*5 | (%)*6 | size (nm) | Volume fraction | (%)*7 | (mass %) |
| a | 1 | F | 100 | 4 | 0.0057 | 4 | 0.061 |
| | 2 | F | 100 | 15 | 0.0057 | 13 | 0.052 |
| b | 3 | F | 100 | 5 | 0.0064 | 5 | 0.057 |
| | 4 | F | 100 | 18 | 0.0064 | 11 | 0.064 |
| c | 5 | F | 100 | 4 | 0.0064 | 4 | 0.071 |
| | 6 | F | 100 | 9 | 0.0064 | 8 | 0.067 |
| d | 7 | F | 100 | 4 | 0.0058 | 3 | 0.058 |
| | 8 | F | 100 | 5 | 0.0021 | 5 | 0.092 |
| e | 9 | F | 100 | 5 | 0.0061 | 3 | 0.054 |
| f | 10 | F + B | 97 | 5 | 0.0074 | 4 | 0.075 |
| g | 11 | F + P | 98 | 6 | 0.0081 | 3 | 0.068 |
| h | 12 | F | 100 | 4 | 0.0069 | 8 | 0.061 |
| I | 13 | F | 100 | 4 | 0.0065 | 5 | 0.059 |
| j | 14 | F + P | 98 | 5 | 0.0086 | 5 | 0.063 |
| k | 15 | F | 100 | 6 | 0.0067 | 4 | 0.057 |
| l | 16 | F | 100 | 4 | 0.0069 | 3 | 0.055 |
| m | 17 | F | 100 | 4 | 0.0067 | 7 | 0.058 |
| n | 18 | F | 100 | 5 | 0.0060 | 4 | 0.063 |
| o | 19 | F | 100 | 5 | 0.0064 | 3 | 0.052 |
| p | 20 | F | 100 | 5 | 0.0015 | 6 | 0.021 |
| q | 21 | F | 100 | 18 | 0.0061 | 12 | 0.064 |
| r | 22 | F + P | 98 | 4 | 0.0021 | 7 | 0.063 |
| s | 23 | F | 100 | 5 | 0.0034 | 6 | 0.019 |
| t | 24 | F + P | 93 | 4 | 0.0153 | 8 | 0.058 |

| | | Mechanical characteristics of hot-rolled steel sheet | | | | | | |
|---|---|---|---|---|---|---|---|---|
| | | Tensile | | Hole expansion | | | | |
| | | strength TS (Mpa) | | ratio λ (%) | | | | |
| | | | One- | | One- | Limit ratio of bend | | |
| | Hot- | | quarter | | quarter | radius (R/t)*8 | | |
| | rolling | Width center | width | Width center | width | Width center | One-quarter | |
| Steel | No. | portion | position | portion | position | portion | width position | Remarks |
| a | 1 | 1052 | 1055 | 45 | 43 | 0.89 | 0.87 | Example |
| | 2 | 812 | 810 | 86 | 87 | 0.89 | 0.87 | Comparative Example |
| b | 3 | 1046 | 1042 | 46 | 45 | 0.81 | 0.86 | Example (plated sheet*2) |
| | 4 | 801 | 782 | 85 | 87 | 0.89 | 0.74 | Comparative Example |
| c | 5 | 1032 | 1034 | 59 | 54 | 0.87 | 0.85 | Example (plated sheet*3) |
| | 6 | 991 | 990 | 36 | 35 | 0.95 | 0.98 | Comparative Example |
| d | 7 | 109 | 1027 | 47 | 50 | 0.81 | 0.79 | Example |
| | 8 | 806 | 800 | 78 | 80 | 0.75 | 0.78 | Comparative Example |
| e | 9 | 1032 | 1034 | 59 | 54 | 0.87 | 0.85 | Example |
| f | 10 | 1011 | 1016 | 46 | 43 | 0.74 | 0.76 | Example |
| g | 11 | 1029 | 1027 | 47 | 50 | 0.81 | 0.79 | Example |
| h | 12 | 998 | 1000 | 51 | 49 | 0.66 | 0.70 | Example |
| I | 13 | 1016 | 1019 | 53 | 52 | 0.59 | 0.62 | Example |
| j | 14 | 1008 | 1007 | 49 | 50 | 0.75 | 0.78 | Example |
| k | 15 | 1003 | 1010 | 46 | 49 | 0.84 | 0.87 | Example (plated sheet*4) |
| l | 16 | 1017 | 1021 | 46 | 45 | 0.73 | 0.81 | Example |
| m | 17 | 997 | 999 | 54 | 57 | 0.87 | 0.84 | Example |
| n | 18 | 1006 | 1010 | 51 | 55 | 0.68 | 0.74 | Example |
| o | 19 | 1013 | 1012 | 49 | 51 | 0.71 | 0.77 | Example |
| p | 20 | 756 | 689 | 82 | 95 | 1.35 | 1.39 | Comparative Example |
| q | 21 | 845 | 816 | 79 | 97 | 0.76 | 0.82 | Comparative Example |
| r | 22 | 851 | 841 | 86 | 88 | 0.81 | 0.83 | Comparative Example |
| s | 23 | 869 | 847 | 27 | 39 | 1.24 | 1.49 | Comparative Example |
| t | 24 | 1103 | 950 | 38 | 58 | 0.68 | 0.71 | Comparative Example |

*2Hot-dip galvarized steel sheet
*3Hot-dip galvannealed steel sheet
*4Hot-dip galvarized steel sheet
*5F denotes ferrite, P denotes pearlite, and B denotes bainite.
*6Area ratio of ferrite phase with respect to overall structure (%)
*7Proportion of the number of carbide with particle size of 30 nm or more with respect to the total number of carbide (%)
*8R (minimum bend radius)/t (sheet thickness)

All our examples are hot-rolled steel sheets having both a high strength at a tensile strength of 980 MPa or more and excellent formability of a hole expansion ratio of λ: 40% or more and a limit ratio of bend radius of 0.9 or less, thus ensuring excellent mechanical characteristics. Moreover, all our examples are hot-rolled steel sheets that meet: a difference in strength between the center of the sheet width (a center portion) and a one-quarter width position of steel sheet is 15 MPa or less, a difference in hole expansion ratio between the center of the sheet width (the center portion) and the one-quarter width position of steel sheet is 10% or less, and a difference in limit ratio of bend radius is 0.15 or less. Thus, stability of the mechanical characteristics and uniformity in strength and formability are demonstrated.

On the other hand, the hot-rolled steel sheets of the comparative examples cannot achieve a desired tensile strength, hole expansion ratio, or limit ratio of bend radius, or causes a large difference in strength and formability in the steel sheet width direction.

1.-10. (canceled)

11. A high strength hot rolled steel sheet comprising:
a chemical composition comprising:
C: more than 0.05% to 0.13% or less;
Si: 0.3% or less;
Mn: 0.5% or more to 2.0% or less;
P: 0.025% or less;
S: 0.005% or less;
N: 0.0060% or less;
Al: 0.1% or less;
Ti: 0.07% or more to 0.18% or less; and
V: more than 0.13% to 0.30% or less on a mass percent basis, such that Ti and V contents satisfy formula (1),
0.25<Ti+V≦0.45 (1)
(where Ti and V are respective contents of the elements (by mass %)), wherein solid solution V: 0.05% or more to less than 0.15%, and balance comprising Fe and inevitable impurities,
a matrix that has a ferrite phase with an area ratio of 95% or more with respect to an overall structure;
a structure where a fine carbide is dispersedly precipitated, the fine carbide containing Ti and V having an average particle size of less than 10 nm in the matrix,
the fine carbide has a volume fraction of 0.0050 or more with respect to the overall structure, and
a proportion of a number of carbides with a particle size of 30 nm or more containing Ti is less than 10% with respect to a total number of carbides,
the high strength hot rolled steel sheet has a tensile strength of 980 MPa or more.

12. The high strength hot rolled steel sheet according to claim 11, wherein the chemical composition further contains at least one selected from the group consisting of Nb and Mo by 1% or less in total on a mass percent basis.

13. The high strength hot rolled steel sheet according to claim 11, wherein the chemical composition further contains at least one selected from the group consisting of Cu, Sn, Ni, Ca, Mg, Co, As, Cr, W, B, Pb, Ta, and Sb by 1% or less in total on a mass percent basis.

14. The high strength hot rolled steel sheet according to claim 12, wherein the chemical composition further contains at least one selected from the group consisting of Cu, Sn, Ni, Ca, Mg, Co, As, Cr, W, B, Pb, Ta, and Sb by 1% or less in total on a mass percent basis.

15. The high strength hot rolled steel sheet according to claim 11, further comprising a plating layer formed at a surface of the high strength hot rolled steel sheet.

16. The high strength hot rolled steel sheet according to claim 11, wherein the high strength hot rolled steel sheet has a hole expansion ratio of 40% or more.

17. The high strength hot rolled steel sheet according to claim 16, wherein the high strength hot rolled steel sheet has a ratio of limit bending radius of 0.9 or less.

18. The high strength hot rolled steel sheet according to claim 17, wherein a difference in a tensile strength between a center position of a sheet width and a position at one-quarter width of the steel sheet is 15 MPa or less, a difference in a hole expansion ratio among the positions is 10% or less, and a difference in a ratio of limit bending radius among the positions is 0.15 or less.

19. A method of producing a high strength hot rolled steel sheet comprising:
preparing a steel material with a chemical composition according to claim 11;
hot-rolling the steel material including rough rolling and finish rolling at a rolling temperature of 880° C. or more to form a hot-rolled steel sheet;
cooling the hot-rolled steel sheet at an average cooling rate of 10° C./sec. or more subsequent to completion of the finish rolling; and
coiling the hot-rolled steel sheet at 550° C. or more to less than 700° C.,

20. The method according to claim 19, further comprising plating a surface of the hot-rolled steel sheet subsequent to the coiling.

21. The high strength hot rolled steel sheet according to claim 12, further comprising a plating layer formed at a surface of the high strength hot rolled steel sheet.

22. The high strength hot rolled steel sheet according to claim 13, further comprising a plating layer formed at a surface of the high strength hot rolled steel sheet.

23. The high strength hot rolled steel sheet according to claim 14, further comprising a plating layer formed at a surface of the high strength hot rolled steel sheet.

24. The high strength hot rolled steel sheet according to claim 12, wherein the high strength hot rolled steel sheet has a hole expansion ratio of 40% or more.

25. The high strength hot rolled steel sheet according to claim 13, wherein the high strength hot rolled steel sheet has a hole expansion ratio of 40% or more.

26. The high strength hot rolled steel sheet according to claim 14, wherein the high strength hot rolled steel sheet has a hole expansion ratio of 40% or more.

27. A method of producing a high strength hot rolled steel sheet comprising:
preparing a steel material with a chemical composition according to claim 12;
hot-rolling the steel material including rough rolling and finish rolling at a rolling temperature of 880° C. or more to form a hot-rolled steel sheet;
cooling the hot-rolled steel sheet at an average cooling rate of 10° C./sec. or more subsequent to completion of the finish rolling; and
coiling the hot-rolled steel sheet at 550° C. or more to less than 700° C.

28. A method of producing a high strength hot rolled steel sheet comprising:
preparing a steel material with a chemical composition according to claim 13;
hot-rolling the steel material including rough rolling and finish rolling at a rolling temperature of 880° C. or more to form a hot-rolled steel sheet;
cooling the hot-rolled steel sheet at an average cooling rate of 10° C./sec. or more subsequent to completion of the finish rolling; and
coiling the hot-rolled steel sheet at 550° C. or more to less than 700° C.

29. A method of producing a high strength hot rolled steel sheet comprising:
preparing a steel material with a chemical composition according to claim 14;
hot-rolling the steel material including rough rolling and finish rolling at a rolling temperature of 880° C. or more to form a hot-rolled steel sheet;
cooling the hot-rolled steel sheet at an average cooling rate of 10° C./sec. or more subsequent to completion of the finish rolling; and
coiling the hot-rolled steel sheet at 550° C. or more to less than 700° C.
